(19) United States
(12) Patent Application Publication
(10) Pub. No.: US 2003/0195311 A1
(43) Pub. Date: Oct. 16, 2003

(54) Multi-component liquid azo-peroxide initiator mixture and method for using same

(75) Inventors: Elisa Martinez, Kilgore, TX (US); Peter Frenkel, Longview, TX (US)

Correspondence Address: Michael P. Dilworth, CROMPTON CORPORATION, Benson Road, Middlebury, CT, 06749, US

(73) Assignee: CROMPTON CORPORATION

(21) Appl. No.: 10/124,553

(22) Filed: Apr. 16, 2002

(51) Int. Cl. C08F 4/04

(52) U.S. Cl. 526/219.3; 526/219.6; 526/227; 526/230; 526/230.5

(57) ABSTRACT

A free radical polymerization process is provided which comprises polymerizing at least one radically polymerizable monomer in the presence of the multi-component liquid azo-peroxide initiator mixture under polymerization conditions to provide a radically polymerized homopolymer or copolymer, the multi-component liquid azo-peroxide initiator mixture comprising (a) at least 6 different azodinitriles; and (b) one or more liquid organic peroxides. Also provided is the stable multi-component liquid azo-peroxide initiator mixture.

### BACKGROUND OF THE INVENTION

1. Technical Field

This invention relates to a multi-component liquid azo-peroxide initiator mixture for free radical polymerization of radically polymerizable monomers, e.g., acrylic monomers.

2. Description of the Related Art

The manufacture of radically polymerized polymers such as acrylic polymers, e.g., polymethyl (methacrylate), is known. Free radical initiators have typically been employed in the polymerization of radically polymerizable monomers to produce the polymerizable polymers. For example, initiators such as azo-initiators, and peroxides are known to effectively initiate the reaction of polymerization. See, e.g., U.S. Pat. Nos. 3,639,553, 3,872,197 and 4,046,850.

Another example of an initiator system is U.S. Pat. No. 4,328,329 which discloses a dual initiator system of tertiary C₄- or tertiary C₅-peroxyneodecanoate and 2,2′-azobis(isobutyronitrile) for polymerization of a methyl methylacrylate polymer syrup to obtain a cast sheet from the methyl methacrylate. However, 2,2′-azobis(isobutyronitrile) is a solid azo-initiator which cannot be dissolved in the liquid peroxide initiator. Thus, pre-blending of these initiators cannot be achieved which precludes the initiator system from being in a true liquid state.

Yet another example of an initiator system is U.S. Pat. No. 5,760,192 which discloses a multi-component liquid azodinitrile mixture of at least six different azodinitriles.

### SUMMARY OF THE INVENTION

It is an object of the present invention to provide a new multi-component liquid azo-peroxide initiator mixture exhibiting long term stability for the free radical polymerization of at least one free radically polymerizable monomer.

It is a particular object of the present invention to provide a process for the polymerization of at least one radically polymerizable monomer, e.g., methyl (methacrylate), to obtain a polymer possessing low color, low residual monomer content and a wide molecular weight range comprising the step of polymerizing at least one radically polymerizable monomer in the presence of the multi-component liquid azo-peroxide initiator mixture.

In keeping with these and other objects of the present invention, there is provided a multi-component liquid azo-peroxide free radical initiator mixture comprising:

(a) at least 6 different azodinitriles; and

(b) one or more liquid organic peroxides.

Further in accordance with the present invention, a free radical polymerization process is provided which comprises the step of polymerizing at least one radically polymerizable monomer in the presence of a multi-component liquid free radical initiator mixture comprising:

(a) at least 6 different azodinitriles; and

(b) one or more liquid organic peroxides to provide a radically polymerized homopolymer or copolymer.

In a preferred embodiment, the radically polymerized monomer(s) are polymerized with a multi-component liquid azo-peroxide free radical initiator mixture comprising:

(a) at least 6 different azodinitriles of the general formula:

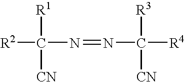

wherein R¹, R², R³ and R⁴ are each independently an alkyl, alicyclic or an alkylalicyclic radical having from 1 to about 9 carbon atoms; and

(b) one or more liquid organic peroxides.

The term “phr” is used herein in its art-recognized sense, i.e., as referring to parts of a respective material per one hundred (100) parts by weight radically polymerized monomer(s).

The resulting radically polymerized homopolymer or copolymer formed from the foregoing multi-component liquid azo-peroxide mixture advantageously possesses a wide molecular weight range and is low in residual monomer content.

### DESCRIPTION OF THE PREFERRED EMBODIMENTS

The present invention provides a multi-component liquid azo-peroxide free radical initiator mixture for use in a free radical polymerization process for polymerizing at least one radically polymerizable monomer.

In accordance with the present invention, the multi-component liquid free radical initiator system comprises a mixture of at least 6 different azodinitrile compounds and one or more organic peroxide compounds as generally described above such that liquid form is obtained at or below about 25° C. Preferably, the mixtures have a maximum freezing point from about 0° C. to about −15° C.

Preferred azodinitrile compounds for use herein possess the general formula:

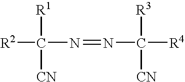

wherein R¹, R², R³ and R⁴ each independently are an unsubstituted straight or branched alkyl, an alicyclic or an alkylalicyclic radical having from about 1 to about 9 carbon atoms including, by way of illustration, unsubstituted straight or branched aliphatic, cycloaliphatic and aromatic groups and cycloaliphatic and aromatic groups substituted with one or more straight or branched aliphatic, cycloaliphatic and/or aromatic groups. Preferably, R¹, R², R³ and R⁴ are each independently selected from the group consisting of acyclic aliphatic hydrocarbon radicals of 1 to about 9 carbon atoms. Suitable components for R¹, R², R³, R⁴, R⁵ and R⁶, include, but are not limited to, methylbutyro, methylpentano, methylheptano, methyloctano, ethylbutano, cyanomethylpropyl, cyanomethylbutyl, cyanodimethylbutyl and the like. The multi-component liquid initiator mixture will ordinarily contain at least 6 different azodinitrile compounds of the foregoing general formula, wherein the azodinitrile compounds are both symmetrical and asymmetrical compounds.

Representative of these azodinitrile compounds and their preparation are known in the art, e.g., U.S. Pat. No. 5,760,192, the contents of which are incorporated by reference herein. In general, the azodinitrile compounds of the present invention can be prepared from 3 or more aminonitriles. The particular azodinitrile product mixture for use in the multi-component liquid initiator mixture obtained depends upon the aminonitrile starting materials employed.

For example, when starting with the following three different aminonitriles:

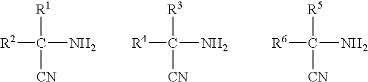

wherein R¹, R², R³, R⁴, R⁵ and R⁶ are, e.g., each independently selected from the group consisting of acyclic aliphatic hydrocarbon radicals of 1 to about 9 carbon atoms, results in an azodinitrile mixture comprising symmetric products such as:

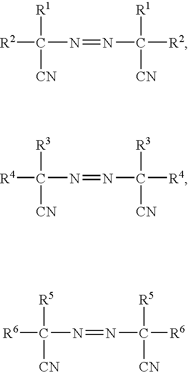

and asymmetric products such as:

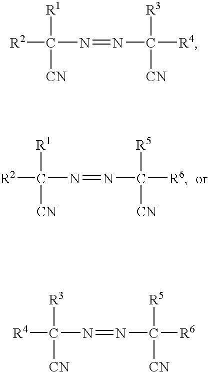

wherein R¹, R², R³, R⁴, R⁵ and R⁶ have the aforestated meanings.

As one skilled in the art will readily appreciate, it can easily be determined that when starting with, for example, three different aminonitriles, there will be three different symmetric azodinitriles, and three different asymmetrical azodinitriles. Accordingly, when starting with four different aminonitriles there will be four different symmetric azodinitriles, and six different asymmetrical azodinitriles. Thus, in the general case when starting with n different aminonitriles there will be n different symmetric azodinitriles, and n!/2(n−2)! different asymmetrical azodinitriles in the resulting product.

Preferred azodinitrile compositions of the present invention are liquid at and have a maximum freezing point of 25° C. and include mixture A as follows:

A. Butanenitrile, 2,2′-azobis(2-methyl-pentanenitrile), 2,2′-azobis(2-methyl-butanenitrile), 2,2′-azobis(2-ethyl-pentanenitrile), 2-[(1-cyano-1-methylpropyl)azo]-2-methyl-pentanenitrile, 2-[(1-cyano-1-ethylpropyl)azo]-2-methyl-butanenitrile, and 2-[(1-cyano-1-methylpropyl)azo]-2-ethyl.

Also preferred is the following mixture B of the present invention having a maximum freezing point of 7° C.

B. Butanenitrile, 2,2′-azobis(2-methyl-heptanenitrile], 2,2′-azobis(2-methyloctanenitrile), 2,2′-azobis(2-methyloctanenitrile), 2-[(1-cyano-1-methylpropyl)azo]-2-methyl-octanenitrile, 2-[(1-cyano-1-methylhexyl)azo]-2-methyl-heptanenitrile, and 2-[(1-cyano-1-methylpropyl)azo]-2-methyl.

More preferred azodinitrile compositions of the present invention are liquid at and have a maximum freezing point of 0° C. and include mixtures C and D as follows:

C. Pentanenitrile, 2,2′-azobis(2-methyl-butanenitrile), 2,2′-azobis(2-ethyl-heptanenitrile), 2,2′-azobis(2-methyl-heptanenitrile), 2-[(1-cyano-1-methylbutyl)azo]-2-methyl-heptanenitrile, 2-[(1-cyano-1-ethylpropyl)azo]-2-methyl-pentanenitrile, 2-[(1-cyano-1-ethylpropyl)azo]-2-methyl; and

D. Butanenitrile, 2,2′-azobis(2-methyl-pentanenitrile), 2,2′-azobis(2-methyl-pentanenitrile), 2,2′-azobis(2,4-dimethyl-heptanenitrile), 2,2′-azobis(2-methyl-heptanenitrile), 2-[(1-cyano-1-methylpropyl)azo]-2-methyl-heptanenitrile, 2-[(1-cyano-1-methylbutyl)azo]-2-methyl-heptanenitrile, 2-[(1-cyano-1,3-dimethylbutyl)azo]-2-methyl-pentanenitrile, 2-[(1-cyano-1-methylbutyl)azo]-2,4-dimethyl-pentanenitrile, 2-[(1-cyano-1-methylpropyl)azo]-2-methyl-pentanenitrile, and 2-[(1-cyano-1-methylpropyl)azo]-2,4-dimethyl.

More particularly preferred azodinitrile compositions of the present invention are liquid at and have a maximum freezing point of −15° C. and include the following mixtures E, F and G:

E. Butanenitrile, 2,2′-azobis(2-methyl-pentanenitrile), 2,2′-azobis(2-methyl-heptanenitrile), 2,2′-azobis(2-methyl-heptanenitrile, 2-[(1-cyano-1-methylpropyl)azo]-2-methyl-heptanenitrile, 2-[(1-cyano-1-methylbutyl)azo]-2-methyl-pentanenitrile, and 2-[(1-cyano-1-methylpropyl)azo]-2-methyl;

F. Butanenitrile, 2,2′-azobis(2-methyl-pentanenitrile), 2,2′-azobis(2-methyl-octanenitrile), 2,2′-azobis(2-methyl-octanenitrile), 2-[(1-cyano-1-methylpropyl)azo]-2-methyl-octanenitrile, 2-[(1-cyano-1-methylbutyl)azo]-2-methyl-pentanenitrile, and 2-[(1-cyano-1-methylpropyl)azo]-2-methyl; and

G. Butanenitrile, 2,2′-azobis(2-methyl-pentanenitrile), 2,2′-azobis(2-methyl-butanenitrile), 2,2′-azobis(2-ethyl-heptanenitrile), 2,2′-azobis(2-methyl-heptanenitrile), 2-[(1-cyano-1-methylpropyl)azo]-2-methyl-heptanenitrile, 2-[(1-cyano-1-methylbutyl)azo]-2-methyl-heptanenitrile, 2-[(1-cyano-1-ethylpropyl)azo]-2-methyl-pentanenitrile, 2-[(1-cyano-1-methylpropyl)azo]-2-methyl-pentanenitrile, 2-[(1-cyano-1-ethylpropyl)azo]-2-methyl-butanenitrile, and 2-[(1-cyano-1-methylpropyl)azo]-2-ethyl.

Suitable organic peroxides for mixing with the azodinitrile compound mixture to provide the multi-component liquid azo-peroxide initiator mixture of this invention are diacyl peroxides, peroxydicarbonates, peroxyesters, oo-t-alkyl o-alkyl monoperoxycarbonates, diperoxyketals, dialkyl peroxides, hydroperoxides, ketone peroxides, wherein the alkyl group for each of the aforestated peroxides is from 1 to about 20 carbon atoms and preferably from about 4 to about 10 carbon atoms, and the like and mixtures thereof. Preferred organic peroxides are diacyl peroxides and peroxyesters and mixtures thereof.

Suitable diacyl peroxides for use herein include, but are not limited to, diacetyl peroxide, diisononanoyl peroxide, and the like and combinations thereof.

Suitable peroxyesters for use herein include, but are not limited to, t-butyl perbenzoate, t-butyl peracetate, t-amyl perbenzoate, 2,5-di(benzoylperoxy)-2,5-dimethylhexane, t-butyl peroxyisobutyrate, t-butyl peroxy-2-ethylhexanoate (t-butyl peroctoate), t-amyl peroctoate, 2,5-di(2-ethylhexanoylperoxy)-2,5-dimethylhexane, t-butyl peroxypivalate, t-amyl peroxypivalate, t-butyl peroxyneodecanoate, t-amyl peroxyneodecanoate, α-cumyl peroxyneodecanoate, and the like and combinations thereof.

Suitable diperoxyketals include, but are not limited to, ethyl 3,3-di(t-butylperoxy)butyrate, ethyl 3,3-di(t-amylperoxy)butyrate, n-butyl 4,4-di(t-butylperoxy)valerate, 2,2-di(t-butylperoxy)butane, 1,1-di(t-butylperoxy)cyclohexane, 1,1-di(t-butylperoxy)3,3,5-trimethylcyclohexane, 1,1-di(t-amylperoxy)cyclohexane, and the like and combinations thereof.

Suitable dialkyl peroxides include, but are not limited to, 2,5-di(t-butylperoxy)-2,5-dimethyl-3-hexyne, di-t-butyl peroxide, t-butyl α-cumyl peroxide, 2,5-di(t-butylperoxy)-2,5-dimethylhexane, and the like and combinations thereof.

Suitable peroxydicarbonate include, but are not limited to, di-n-propyl peroxydicarbonate, diisopropyl peroxydicarbonate, dicetyl peroxydicarbonate, di-sec-butyl peroxydicarbonate, and the like and combinations thereof.

Suitable hydroperoxides include, but are not limited to, t-butyl hydroperoxide, t-amyl hydroperoxide, cumene hydroperoxide, pinane hydroperoxide, para-menthane hydroperoxide, and the like and combinations thereof.

The multi-component liquid azo-peroxide mixture of this invention is obtained by mixing the azodinitrile compound mixture and organic peroxide(s) in suitable amounts. In general, the azodinitrile compound mixture will ordinarily be added in amounts ranging from about 5 to about 95 weight percent, and preferably from about 20 to about 50 weight percent based on total weight of multi-component mixture with the organic peroxide(s) forming the remaining portion of the mixture.

The multi-component liquid azo-peroxide initiator mixture of this invention is particularly useful as free radical polymerization initiators for radically polymerizable monomers. One class of radically polymerizable monomers suitable for use in the present invention are C₃-C₆ monoethylenically unsaturated monocarboxylic acids, their esters and the alkaline metal and ammonium salts thereof. The C₃-C₆ monoethylenically unsaturated monocarboxylic acids include, but are not limited to, acrylic acid, methacrylic acid, crotonic acid, vinyl acedic acid, and acryloxypropionic acid. Acrylic acid and methacrylic acid are the preferred monoethylenically unsaturated monocarboxylic acid monomers.

Another class of monomers suitable for use in the present invention are C₄-C₆ monoethylenically unsaturated dicarboxylic acids and the alkaline metal and ammonium salts thereof, and the anhydrides of the cis dicarboxylic acids. Suitable examples include, but are not limited to, maleic acid, maleic anhydride, itaconic acid, mesaconic acid, fumaric acid, and citraconic acid. Maleic anhydride and itaconic acid are preferred monoethylenically unsaturated dicarboxylic acid monomers.

The monomers useful in this invention may be in their acid forms or in the form of the alkaline metal or ammonium salts of the acid. Suitable bases useful for neutralizing the monomer acids includes sodium hydroxide, ammonium hydroxide, potassium hydroxide, and the like. The acid monomers may be neutralized to a level of from 0 to 50% and preferably from 5 to about 20%. More preferably, the carboxylic acid monomers are used in the completely neutralized form.

In addition, up to 100% by weight of the total polymerizable monomers may be monoethylenically unsaturated carboxylic acid-free monomers. Typical monoethylenically unsaturated carboxylic acid-free monomers suitable for use in the invention include, but are not limited to, alkyl esters of acrylic or methacrylic acids where the alkyl group is from 1 to about 6 carbon atoms such as, for example, methyl acrylate, ethyl acrylate, butyl acrylate; hydroxyalkyl esters of acrylic or methacrylic acid where the alkyl group is from 1 to about 6 carbon atoms such as hydroxyethyl acrylate, hydroxypropyl acrylate, hydroxyethyl methacrylate, and hydroxypropyl methacrylate; acrylamide, methacrylamide, N-t-butylacrylamide, N-methylacrylamide, N,N-dimethyl acrylamide; acrylonitrile, methacrylonitrile, dimethylaminoethyl acrylate, dimethylaminoethyl methacrylate, phosphoethyl methacrylate, N-vinyl pyrrolidone, N-vinylformamide, N-vinylimidazole, vinyl acetate, styrene, hydroxylated styrene, styrenesulfonic acid and salts thereof, vinylsulfonic acid and salts thereof, and 2-acrylamido-2-methylpropanesulfonic acid and salts thereof.

Other suitable comonomers include acrylamides, alkyl and aryl amide derivatives thereof, and quaternized alkyl and aryl acrylamide derivatives.

In polymerizing the foregoing radically polymerizable monomer(s), the multi-component liquid azo-peroxide initiator mixture is added in a free radical polymerizable amount, e.g., amounts ranging from about 0.1 to about 10 phr, preferably from about 0.5 to about 3 phr and most preferably from about 0.75 to about 1 phr. Polymerization conditions under which the foregoing radically polymerizable monomer and multi-component liquid azo-peroxide initiator mixture are subjected to include thermal treatment such that a complete cure is advantageously achieved.

In addition to the multi-component liquid azo-peroxide mixture of the present invention, one or more other commonly used additives can be present in the radically polymerized homo- or copolymer. These other additives, according to necessity, include, but are not limited to, inhibitors, stabilizers, fillers, slip agents, dyes, and the like and combinations thereof.

By employing the multi-component liquid azo-initiator mixture in the process of the present invention, a conversion and degree of polymerization of the radically polymerizable monomer(s) as high as about 99% by weight is advantageously achieved. Additionally, the resulting homopolymer or copolymers obtained from the process of the present invention will possess as desired either low or high an average molecular weight (M_{W}).

The resulting polymers obtained from the process of this invention are particularly useful for applications which include, for example, toner compositions, adhesives, cellulosic fiber binders, compatibilizers for thermoplastic blends, emulsifiers, thickeners, processing aids for thermoplastic resins, pigment dispersants, coatings, asphalt modifiers, molded articles, sheet molding compounds, and impact modifiers.

The following non-limiting examples are illustrative of the present invention.

### Preparation of Syrup

Methyl methacrylate syrup was prepared by dissolving 15% polymerized methyl methacrylate (PMMA) in uninhibited methyl methacrylate (MMA).

### Initiators

The following organic peroxides were used: t-butyl peroxyneodecanoate (a 75% solution in odorless mineral spirits (OMS)), t-butyl peroxypivalate (a 75% solution in OMS), t-amyl peroxy 2-ethyl hexanoate (technically pure), and diisononanoyl peroxide (a 60% solution in OMS). The azodinitrile initiator mixture used was Liquid Vazo® (from DuPont) which contains six different azodinitrile compounds.

### Preparation of Azo-Peroxide Blends

The azo-peroxide mixtures used in the Examples set forth below were prepared by mixing Liquid Vazo® with the organic peroxide in percent weight ratios in plastic bottles and stored at −15° C. Blends exhibited excellent long term stability and reactivity when stored at this temperature.

### Cell Casting

A casting cell was assembled by placing two pyroceramic glass plates, 6 inches×6 inches×3/16 inches, together with a silicon rubber tubing, 1/32 inches ID×5/32 inches OD×1/16 inches wall, between them. The tubing was placed in a square pattern around the glass plates to give a cell that was roughly 5 inches×5 inches. The top of the cell was left open for filling with enough tubing left over for closure. Six binder clips were used to hold the cell together, two on each side, leaving the top open.

Using a 20 ml syringe, the methyl methacrylate syrup and initiator were added into the glass cell. The bubbles were allowed to disperse, and then the left over tubing was pushed down over the top to seal the cell. The end of the tubing was pinched closed with two clamps. A hypodermic thermocouple, type J, was inserted through the tubing and into the resin. This thermocouple was connected to a recorder and computer to record the time and temperature of the exotherm. The cell was placed in a 1:1 glycol:water bath that had been heated to the desired temperature (60-67° C.). The cell was heated for about 15 minutes after exotherm, then removed and placed in an oven set for about 130° C. for about one hour. The cell was then cooled at room temperature for at least an hour before the glass was removed.

### Gel Permeation Chromatography

The samples were chromatographed on a Waters 2690, at 35° C. Polymerized methyl methacrylate samples from cell casting were cut into 10 g samples. Samples were dissolved in tetrahydrofurane (THF) at room temperature and were filtered through a 0.45 micron filter prior to gel permeation chromatography. A 600K PMMA broad molecular weight distribution standard was used for first order calibration.

### Residual Methyl Methacrylate Monomer Analysis

A 0.5 g sample of polymerized methyl methacrylate made from the cell casting was ground to a fine powder using dry ice to stop any melting or degradation. The samples were extracted with a soxhlet extractor overnight in 125 ml methanol. This extract was then concentrated to 50 ml and the sample analyzed by gas chromatography as discussed above.

### EXAMPLES 1 AND 2/COMPARATIVE EXAMPLES A AND B

Azo-peroxide mixtures containing 10 weight percent of Liquid Vazo® in t-butyl peroxyneodecanoate and 30 weight percent Liquid Vazo® in t-butyl peroxyneodecanoate were prepared at room temperature for cell casting. The initiator mixtures were each added to the methyl methacrylate syrup as prepared above at 1 phr and then placed in a cell casting mold as described above. The molds were heated to 60° C. until 15 minutes past the peak exotherm, then the samples were post cured in a dry oven at about 130° C. for about one hour.

The samples were then compared to control samples Comparative Examples A and B. Comparative Example A was prepared by adding 1 phr of Liquid Vazo® alone to the methyl methacrylate syrup and then placed in a cell casting mold. Comparative Example B was prepared by adding 1 phr of t-butyl peroxyneodecanoate to the methyl methacrylate syrup and then placed in a cell casting mold. Each mold for Comparative Examples A and B was heated to 60° C. until 15 minutes past the peak exotherm, then the samples were post cured in a dry oven at about 130° C. for about one hour.

Examples 1 and 2 and Comparative Examples A and B were then compared by evaluating the peak exotherm temperature, time to peak exotherm, average molecular weight, residual monomer content, and outward appearance for each sample as set forth in Table 1 below.

TABLE I
Physical Properties and Characteristics of PMMA Cell Castings Obtained With The Use of Liquid
Vazo ® and t-Butyl Peroxyneodecanoate Alone and Blends Thereof.

| | | | Peak | Time to | % Residual | Average | |
|---|---|---|---|---|---|---|---|
| | | Casting | Exotherm | Peak | MMA | Molecular | Appearance |
| Sample | Initiator | Temp (° C.) | Temp (° C.) | Exo (min) | Monomer | Weight* | of MMA Cell |
| Comp. | Liquid | 60 | 68.36 | 74.8 | 0.15 | 1270490 | Minimal |
| Ex. A | Vazo ® | | | | | | bubbles |
| Ex. 2 | 3:7 Azo: | 60 | 83.01 | 38.0 | 0.18 | 999578 | Small |
| | Peroxide | | | | | | bubbles, |
| | | | | | | | upper ⅓ of |
| | | | | | | | cell |
| Ex. 1 | 1:9 Azo: | 60 | 97.66 | 34.3 | 0.16 | 699075 | Minimal |
| | Peroxide | | | | | | bubbles |
| Comp. | Peroxide | 60 | 107.42 | 33.0 | 0.09 | 980482 | Small |
| Ex. B | | | | | | | bubbles, |
| | | | | | | | upper ¼ of |
| | | | | | | | cell |

*Results are listed in PMMA units

As the above data show, Comparative Example B using t-butyl peroxyneodecanoate alone had the highest exotherm at 107.42° C. and shortest time to exotherm at 33 minutes which was characteristic of its reactivity. By adding small percentages of Liquid Vazo® (Examples 1 and 2), lower exotherms and longer times to peak exotherm were observed. However, the peak exotherm temperatures were not observed to drop at a linear rate based upon the amount of Liquid Vazo® added. In fact, just 10% Liquid Vazo® in t-butyl peroxyneodecanoate of Example 1 resulted in about a 10 degree drop in temperature at 97.66° C., almost 25% of the difference between the peak exotherm temperatures observed with t-butyl peroxyneodecanoate at 107.42° C. and Liquid Vazo® at 68.36° C. At the same time there was only a 1.3 minute slowing of the exotherm time, only 3% of the time difference between the pure components. Also, 30% Liquid Vazo® in t-butyl peroxyneodecanoate of Example 2 resulted in about a 24 degree temperature drop at 83.01° C. This correlated to about 62% of the total exotherm temperature difference with only a 5 minute decrease in exotherm time, which was about 12% of the exotherm time difference. This rapid drop in peak exotherm temperature without sacrificing time to peak exotherm when only a small amount of azodinitrile initiator was added to the peroxide indicated a type of synergy that could not be predicted between the two initiators and was entirely unexpected.

Physical properties of the PMMA prepared in Examples 1 and 2 and Comparative Examples A and B were also evaluated. Gel permeation chromatography was used to determine the average molecular weight of each cell casting sample. The cell casting sample made with Liquid Vazo® (i.e., Comparative Example A) at 60° C. had an average molecular weight value of 1.27×10⁶ and the sample prepared with t-butyl peroxyneodecanoate (i.e., Comparative Example B) had an average molecular weight value of 0.98×10⁶. Example 1 yielded a much lower average molecular weight value, 0.70×10⁶, than either of Comparative Examples A and B which indicated a type of synergy. For example, this was 29% lower than what was observed for Comparative Example B. Example 2 (prepared with a 30% blend of Liquid Vazo® in t-butyl peroxyneodecanoate) had an average molecular weight value of 1×10⁶. This value was similar to the value obtained for Comparative Example A and B.

For residual monomer content, all values for the samples were low, with relatively little difference between the percentages. After polymerization, MMA content was no more than 0.18%. It was also observed that lowering the concentration of Liquid Vazo® in the samples reduced bubbling.

When evaluating all of these parameters together, Examples 1 and 2 provided the speed associated with the use of t-butyl peroxyneodecanoate alone yet with a lower peak exotherm temperature. It was also noteworthy that the average molecular weight value for Example 1 was lower than either of the values obtained for Comparative Examples A and B which indicated a synergy with the blend.

### EXAMPLES 3 AND 4/COMPARATIVE EXAMPLES C AND D

Azo-peroxide mixtures containing 10 weight percent Liquid Vazo® in t-butyl peroxypivalate and 30 weight percent Liquid Vazo® in t-butyl peroxypivalate were prepared at room temperature for cell casting. The initiator mixtures were each added to methyl methacrylate syrup as prepared above at 1 phr and then placed in a cell casting mold as described above. The molds were heated to 60° C. until 15 minutes past the peak exotherm, then the samples were post cured in a dry oven at about 130° C. for about one hour.

The samples were then compared to Comparative Examples C and D as control samples which polymerized methyl methacrylate syrup with Liquid Vazo® and t-butyl peroxypivalate, respectively, as single initiators. The samples were prepared in a similar manner as discussed above with respect to Comparative Examples A and B.

Examples 3 and 4 and Comparative Examples C and D were then compared by evaluating peak exotherm temperature, time to peak exotherm, average molecular weight, residual monomer content, and outward appearance for each sample as set forth in Table II below.

TABLE II
Physical Properties and Characteristics of PMMA Cell Casting Obtained With The Use of Liquid
Vazo ® and t-Butyl Peroxypivalate Alone And Blends Thereof

| | | | Peak | Time to | % Residual | Average | |
|---|---|---|---|---|---|---|---|
| | | Casting | Exotherm | Peak | MMA | Molecular | Appearance of |
| Sample | Initiator | Temp (° C.) | Temp (° C.) | Exo (min) | Monomer | Weight* | MMA Cell |
| Comp. | Liquid | 60 | 68.36 | 74.8 | 0.15 | 1270490 | Minimal |
| Ex. C | Vazo ® | | | | | | bubbles |
| Ex. 4 | 3:7 Azo: | 60 | 78.13 | 52.2 | 0.27 | 1230572 | Minimal |
| | Peroxide | | | | | | bubbles |
| Ex. 3 | 1:9 Azo: | 60 | 83.01 | 48.6 | 0.07 | 1069188 | Minimal |
| | Peroxide | | | | | | bubbles |
| Comp. | Peroxide | 60 | 97.66 | 46.7 | 0.05 | 1001800 | Minimal |
| Ex. D | | | | | | | bubbles |

*Results are listed in PMMA units

As the above data show, the use of the single initiator t-butyl peroxypivalate in Comparative Example D exhibited the highest exotherm at 97.66° C. and fastest time to exotherm at 46.7 minutes. By adding Liquid Vazo® to the peroxide (Examples 3 and 4), lower exotherm temperatures and shorter exotherm times were observed. However, the peak exotherm temperatures were not observed to drop at a linear rate based upon the amount of Liquid Vazo® added thereto. For example, when 10% Liquid Vazo® was added to t-butyl peroxypivalate, there was a about a 14.5° C. drop in peak exotherm temperature to 83.01° C., which was about 50% of the difference between the peak exotherms observed for t-butyl peroxypivalate at 97.66° C. and Liquid Vazo® at 68.36° C. alone. Also, the peak exotherm time only decreased by about 2 minutes, which was about 7% of the time difference between the two single initiators. By adding 30% Liquid Vazo® to t-butyl peroxypivalate, a 19.5 degree drop in exotherm temperature to 78.13° C. resulted, which was about 67% of the total exotherm temperature difference. Thus, the peak exotherm time was only decreased by 5.5 minutes, about 20% of the total exotherm time difference of the two single initiators. This significant drop in peak exotherm temperature in such a short period of time indicated a synergy between the two initiators when blended together which was entirely unexpected.

When evaluating all of these parameters together, Examples 3 and 4 containing 10 and 30% Liquid Vazo® in t-butyl peroxypivalate, respectively, for polymerizing MMA syrup, provided the speed associated with t-butyl peroxypivalate alone yet with a lower peak exotherm temperature. The average molecular weight value was observed to be linear in change for Example 3, but Example 4 approached a value closer to that obtained for the single Liquid Vazo® initiator in Comparative Example C. The physical appearance of each sample showed minimal bubbling and imperfections for all the initiators and their blends tested. Additionally, the residual monomer content after polymerization was low for all samples, no more than 0.27%.

### EXAMPLES 5 AND 6/COMPARATIVE EXAMPLES E AND F

Azo-peroxide mixtures containing 10 weight percent of Liquid Vazo® in t-amyl peroxy 2-ethyl hexanoate and 30 weight percent Liquid Vazo® in t-amyl peroxy 2-ethyl hexanoate were prepared at room temperature for cell casting. The initiator mixtures were each added to the methyl methacrylate syrup as prepared above at 1 phr and then placed in a cell casting mold as described above. The molds were heated to 67° C. until 15 minutes past the peak exotherm, then the samples were post cured in a dry oven at about 130° C. for about one hour.

The samples were then compared to Comparative Examples E and F as control samples. Comparative Example E was prepared by adding 1 phr of Liquid Vazo® alone to the methyl methacrylate syrup and then placed in a cell casting mold. Comparative Example F was prepared by adding 1 phr of t-amyl peroxy 2-ethyl hexanoate to the methyl methacrylate syrup and then placed in a cell casting mold. Each mold for Comparative Examples E and F was heated to 67° C. until 15 minutes past the peak exotherm, then the samples were post cured in a dry oven at about 130° C. for about one hour.

Examples 5 and 6 and Comparative Examples E and F were then compared by evaluating the peak exotherm temperature, time to peak exotherm, average molecular weight, residual monomer content, and outward appearance for each sample as set forth in Table III below.

TABLE III
Physical Properties and Characteristics of PMMA Cell Castings Obtained with the Use of Liquid
Vazo ® and t-Amyl Peroxy 2-Ethyl Hexanoate Alone and Blends Thereof

| | | | Peak | Time to | % Residual | Average | |
|---|---|---|---|---|---|---|---|
| | | Casting | Exotherm | Peak | MMA | Molecular | Appearance of |
| Sample | Initiator | Temp (° C.) | Temp (° C.) | Exo (min) | Monomer | Weight* | MMA Cell |
| Comp. | Liquid | 67 | 100.10 | 43.7 | 0.18 | 818392 | Large bubbles |
| Ex. E | Vazo ® | | | | | | dispersed |
| | | | | | | | throughout |
| Ex. 6 | 3:7 Azo: | 67 | 95.21 | 51.8 | 0.14 | 1088021 | Minimal |
| | Peroxide | | | | | | bubbles |
| Comp. | Peroxide | 67 | 104.98 | 55.3 | 0.11 | 1140267 | Minimal |
| Ex. F | | | | | | | bubbles |

*Results are listed in PMMA units

As the above data show, Comparative Example F using the single initiator t-amyl peroxy 2-ethyl hexanoate had the highest peak exotherm at 104.98° C. and the longest time to peak exotherm at 55.3 minutes as compared to Comparative Example E with a peak exotherm temperature of 100.1° C. and a time to peak exotherm of 43.7 minutes. Example 6 had a peak exotherm that was lower than both of the single initiators. This lowering of peak exotherm temperature below both single initiator systems suggested a type of synergy in the blend which was unexpected.

When evaluating all of these parameters together, Example 6 containing 30% Liquid Vazo® in t-amyl peroxy 2-ethyl hexanoate in MMA syrup provided a lower peak exotherm temperature than both of the single initiators, and yet the average molecular weight value was linear in change. Also, minimal bubbling and surface imperfections were observed for the final samples as well. Moreover, the residual monomer content after polymerization was low for all samples, no more than 0.18%.

### EXAMPLES 7 AND 8/COMPARATIVE EXAMPLES G AND H

Azo-peroxide mixtures containing 10 weight percent of Liquid Vazo® in diisononanoyl peroxide and 30 weight percent Liquid Vazo® in diisononanoyl peroxide were prepared at room temperature for cell casting. The initiator mixtures were each added to the methyl methacrylate syrup as prepared above at 1 phr and then placed in a cell casting mold as described above. The molds were heated to 67° C. until 15 minutes past the peak exotherm, then the samples were post cured in a dry oven at about 130° C. for about one hour.

The samples were then compared to Comparative Examples G and H as control samples. Comparative Example G was prepared by adding 1 phr of Liquid Vazo® alone to the methyl methacrylate syrup and then placed in a cell casting mold. Comparative Example H was prepared by adding 1 phr of diisononanoyl peroxide to the methyl methacrylate syrup and then placed in a cell casting mold. Each mold for Comparative Examples G and H was heated to 67° C. until 15 minutes past the peak exotherm, then the samples were post cured in a dry oven at about 130° C. for about one hour.

Examples 7 and 8 and Comparative Examples G and H were then compared by evaluating the peak exotherm temperature, time to peak exotherm, average molecular weight, residual monomer content, and outward appearance for each sample as set forth in Table IV below.

TABLE IV
Physical Properties and Characteristics of PMMA Cell Castings Obtained With The Use of
Liquid Vazo ® and Diisononanoyl Peroxide Alone And Blends Thereof

| | | | Peak | Time to | % Residual | Average | |
|---|---|---|---|---|---|---|---|
| | | Casting | Exotherm | Peak | MMA | Molecular | Appearance of |
| Sample | Initiator | Temp (° C.) | Temp (° C.) | Exo (min) | Monomer | Weight* | MMA Cell |
| Comp. | Liquid | 67 | 100.10 | 43.7 | 0.18 | 818392 | Large bubbles |
| Ex. G | Vazo ® | | | | | | dispersed |
| | | | | | | | throughout |
| Ex. 8 | 3:7 Azo: | 67 | 100.10 | 49.9 | 0.17 | 1344481 | Minimal |
| | Peroxide | | | | | | bubbles |
| Comp. | Peroxide | 67 | 109.86 | 51.6 | 0.09 | 1148304 | Minimal |
| Ex. H | | | | | | | bubbles |

*Results are listed in PMMA units

As the above data show, Comparative Example H had the highest peak exotherm temperature at 109.86° C. and the longest time to peak exotherm at 51.6 minutes as compared to Comparative Example G with a peak exotherm of 100.1° C. and a time to peak exotherm of 43.7 minutes. Example 8 had a peak exotherm temperature that was about 9 degrees lower than Comparative Example G, but exactly the same as Comparative Example H. However, the time to peak exotherm for Example 8 was 2 minutes shorter, about 22% of the exotherm time difference between Comparative Examples G and H.

When evaluating all of these parameters together, it can be noted that a blend of 30% Liquid Vazo® and diisononanoyl peroxide in MMA syrup provided a peak exotherm temperature similar to Liquid Vazo® but lower than diisononanoyl peroxide. Also cure speeds were slower than Liquid Vazo® but surface imperfections were reduced which was highly desirable. The average molecular weight value obtained for the blend of 30% Liquid Vazo® in diisononanoyl peroxide was higher, about 17% than either of the values obtained for single initiators. Also, residual monomer content after polymerization was low for all samples, no more than 0.18%. Minimal bubbling and surface imperfections were also observed for the final samples as well.

It will be understood that various modifications may be made to the embodiments disclosed herein. Therefore the above description should not be construed as limiting, but merely as exemplifications of preferred embodiments. Accordingly, other arrangements and methods may be implemented by those skilled in the art without departing from the scope and spirit of this invention. Moreover, those skilled in the art will envision other modifications within the scope and spirit of the claims appended hereto.

What is claimed is:

1. A free radical polymerization process comprising the step of polymerizing at least one radically polymerizable monomer in the presence of a multi-component liquid azo-peroxide initiator mixture under polymerization conditions to provide a radically polymerized homopolymer or copolymer, the multi-component liquid azo-peroxide initiator mixture comprising:
(a) at least 6 different azodinitriles; and
(b) one or more liquid organic peroxides.

2. The process of claim 1 wherein the radically polymerizable monomer is monoethylenically unsaturated carboxylic acid-free monomer selected from the group consisting of alkyl esters of acrylic or methacrylic acids and hydroxyalkyl esters of acrylic or methacrylic acid.

3. The process of claim 2 wherein the alkyl esters of acrylic acid are selected from the group consisting of methyl acrylate, ethyl acrylate, propyl acrylate, and butyl acrylate.

4. The process of claim 2 wherein the alkyl esters of methacrylic acid are selected from the group consisting of methyl methacrylate, ethyl methacrylate, propyl methacrylate and butyl methacrylate.

5. The process of claim 1 wherein the radically polymerizable monomer is alkyl acrylate or alkyl methacrylate.

6. The process of claim 1 wherein the 6 different azodinitriles are of the general formula: 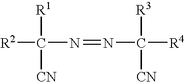
wherein R¹, R², R³ and R⁴ are each independently an alkyl, alicyclic or an alkylalicyclic radical having from 1 to about 9 carbon atoms.

7. The process of claim 6 wherein R¹, R², R³ and R⁴ of the azodinitriles in the multi-component liquid initiator mixture are each independently selected from the group consisting of methylbutyro, methylpentano, methylheptano, methyloctano, ethylbutano, cyanomethylpropyl, cyanomethylbutyl and cyanodimethylbutyl.

8. The process of claim 1 wherein the azodinitriles in the multi-component liquid initiator mixture are selected from the group consisting of mixtures A and B
A. Butanenitrile, 2,2′-azobis(2-methyl-pentanenitrile), 2,2′-azobis(2-methyl-butanenitrile), 2,2′-azobis(2-ethyl-pentanenitrile), 2-[(1-cyano-1-methylpropyl)azo]-2-methyl-pentanenitrile, 2-[(1-cyano-1-ethylpropyl)azo]-2-methyl-butanenitrile, and 2-[(1-cyano-1-methylpropyl)azo]-2-ethyl; and
B. Butanenitrile, 2,2′-azobis(2-methyl-heptanenitrile], 2,2′-azobis(2-methyloctanenitrile), 2,2′-azobis(2-methyl-octanenitrile), 2-[(1-cyano-1-methylpropyl)azo]-2-methyl-octanenitrile, 2-[(1-cyano-1-methylhexyl)azo]-2-methyl-heptanenitrile, and 2-[(1-cyano-1-methylpropyl)azo]-2-methyl;
the azodinitriles having a freezing point of a maximum of 25° C.

9. The process of claim 1 wherein the azodinitriles in the multi-component liquid initiator mixture are selected from the group consisting of mixtures C and D
C. Pentanenitrile, 2,2′-azobis(2-methyl-butanenitrile), 2,2′-azobis(2-ethyl-heptanenitrile), 2,2′-azobis(2-methyl-heptanenitrile), 2-[(1-cyano-1-methylbutyl)azo]-2-methyl-heptanenitrile, 2-[(1-cyano-1-ethylpropyl)azo]-2-methyl-pentanenitrile, 2-[(1-cyano-1-ethylpropyl)azo]-2-methyl; and
D. Butanenitrile, 2,2′-azobis(2-methyl-pentanenitrile), 2,2′-azobis(2-methyl-pentanenitrile), 2,2′-azobis(2,4-dimethyl-heptanenitrile), 2,2′-azobis(2-methyl-heptanenitrile), 2-[(1-cyano-1-methylpropyl)azo]-2-methyl-heptanenitrile, 2-[(1-cyano-1-methylbutyl)azo]-2-methyl-heptanenitrile, 2-[(1-cyano-1,3-dimethylbutyl)azo]-2-methyl-pentanenitrile, 2-[(1-cyano-1-methylbutyl)azo]-2,4-dimethyl-pentanenitrile, 2-[(1-cyano-1-methylpropyl)azo]-2-methyl-pentanenitrile, and 2-[(1-cyano-1-methylpropyl)azo]-2,4-dimethyl the azodinitriles having a freezing point of a maximum of 0° C.

10. The process of claim 1 wherein the azodinitriles in the multi-component liquid initiator mixture are selected from the group consisting of mixtures E, F and G
E. Butanenitrile, 2,2′-azobis(2-methyl-pentanenitrile), 2,2′-azobis(2-methyl-heptanenitrile), 2,2′-azobis(2-methyl-heptanenitrile, 2-[(1-cyano-1-methylpropyl)azo]-2-methyl-heptanenitrile, 2-[(1-cyano-1-methylbutyl)azo]-2-methyl-pentanenitrile, and 2-[(1-cyano-1-methylpropyl)azo]-2-methyl;
F. Butanenitrile, 2,2′-azobis(2-methyl-pentanenitrile), 2,2′-azobis(2-methyl-octanenitrile), 2,2′-azobis(2-methyl-octanenitrile), 2-[(1-cyano-1-methylpropyl)azo]-2-methyl-octanenitrile, 2-[(1-cyano-1-methylbutyl)azo]-2-methyl-pentanenitrile, and 2-[(1-cyano-1-methylpropyl)azo]-2-methyl; and
G. Butanenitrile, 2,2′-azobis(2-methyl-pentanenitrile), 2,2′-azobis(2-methyl-butanenitrile), 2,2′-azobis(2-ethyl-heptanenitrile), 2,2′-azobis(2-methyl-heptanenitrile), 2-[(1-cyano-1-methylpropyl)azo]-2-methyl-heptanenitrile, 2-[(1-cyano-1-methylbutyl)azo]-2-methyl-heptanenitrile, 2-[(1-cyano-1-ethylpropyl)azo]-2-methyl-pentanenitrile, 2-[(1-cyano-1-methylpropyl)azo]-2-methyl-pentanenitrile, 2-[(1-cyano-1-ethylpropyl)azo]-2-methyl-butanenitrile, and 2-[(1-cyano-1-methylpropyl)azo]-2-ethyl
the azodinitriles having a freezing point of a maximum of −15° C.

11. The process of claim 1 wherein the liquid organic peroxides in the multi-component liquid initiator mixture are selected from the group consisting of diacyl peroxides, peroxydicarbonates, peroxyesters, oo-t-alkyl o-alkyl monoperoxycarbonates, diperoxyketals, dialkyl peroxides, hydroperoxides, and ketone peroxides.

12. The process of claim 11 wherein the diacyl peroxides are selected from the group consisting of diacetyl peroxide, diisononanoyl peroxide, and combinations thereof.

13. The process of claim 11 wherein the peroxyesters are selected from the group consisting of t-butyl perbenzoate, t-butyl peracetate, t-amyl perbenzoate, 2,5-di(benzoylperoxy)-2,5-dimethylhexane, t-butyl peroxyisobutyrate, t-butyl peroxy-2-ethylhexanoate (t-butyl peroctoate), t-amyl peroctoate, 2,5-di(2-ethylhexanoylperoxy)-2,5-dimethylhexane, t-butyl peroxypivalate, t-amyl peroxypivalate, t-butyl peroxyneodecanoate, t-amyl peroxyneodecanoate, α-cumyl peroxyneodecanoate, and combinations thereof.

14. The process of claim 6 wherein the radically polymerizable monomer is an alkyl ester of acrylic or methacrylic acids, the azodinitriles in the multi-component liquid initiator mixture are selected from the group consisting of mixtures E, F and G
E. Butanenitrile, 2,2′-azobis(2-methyl-pentanenitrile), 2,2′-azobis(2-methyl-heptanenitrile), 2,2′-azobis(2-methyl-heptanenitrile, 2-[(1-cyano-1-methylpropyl)azo]-2-methyl-heptanenitrile, 2-[(1-cyano-1-methylbutyl)azo]-2-methyl-pentanenitrile, and 2-[(1-cyano-1-methylpropyl)azo]-2-methyl;
F. Butanenitrile, 2,2′-azobis(2-methyl-pentanenitrile), 2,2′-azobis(2-methyl-octanenitrile), 2,2′-azobis(2-methyl-octanenitrile), 2-[(1-cyano-1-methylpropyl)azo]-2-methyl-octanenitrile, 2-[(1-cyano-1-methylbutyl)azo]-2-methyl-pentanenitrile, and 2-[(1-cyano-1-methylpropyl)azo]-2-methyl; and
G. Butanenitrile, 2,2′-azobis(2-methyl-pentanenitrile), 2,2′-azobis(2-methyl-butanenitrile), 2,2′-azobis(2-ethyl-heptanenitrile), 2,2′-azobis(2-methyl-heptanenitrile), 2-[(1-cyano-1-methylpropyl)azo]-2-methyl-heptanenitrile, 2-[(1-cyano-1-methylbutyl)azo]-2-methyl-heptanenitrile, 2-[(1-cyano-1-ethylpropyl)azo]-2-methyl-pentanenitrile, 2-[(1-cyano-1-methylpropyl)azo]-2-methyl-pentanenitrile, 2-[(1-cyano-1-ethylpropyl)azo]-2-methyl-butanenitrile, and 2-[(1-cyano-1-methylpropyl)azo]-2-ethyl, the azodinitriles having a freezing point of a maximum of −15° C. and the organic peroxide is selected from the from the group consisting of diacyl peroxides and peroxyesters.

15. The process of claim 1 wherein the multi-component liquid azo-peroxide initiator mixture is present in an amount of from about 0.1 to about 10 phr.

16. A multi-component liquid azo-peroxide initiator mixture comprising:
(a) at least 6 different azodinitriles; and
(b) one or more liquid organic peroxides.

17. The multi-component liquid azo-peroxide initiator mixture of claim 16 wherein the 6 different azodinitriles are of the general formula: 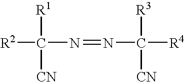
wherein R¹, R², R³ and R⁴ are each independently an alkyl, alicyclic or an alkylalicyclic radical having from 1 to about 9 carbon atoms.

18. The multi-component liquid azo-peroxide initiator mixture of claim 17 wherein R¹, R², R³ and R⁴ of the azodinitriles in the multi-component liquid initiator mixture are each independently selected from the group consisting of methylbutyro, methylpentano, methylheptano, methyloctano, ethylbutano, cyanomethylpropyl, cyanomethylbutyl and cyanodimethylbutyl.

19. The multi-component liquid azo-peroxide initiator mixture of claim 16 wherein the azodinitriles are selected from the group consisting of mixtures A and B
A. Butanenitrile, 2,2′-azobis(2-methyl-pentanenitrile), 2,2′-azobis(2-methyl-butanenitrile), 2,2′-azobis(2-ethyl-pentanenitrile), 2-[(1-cyano-1-methylpropyl)azo]-2-methyl-pentanenitrile, 2-[(1-cyano-1-ethylpropyl)azo]-2-methyl-butanenitrile, and 2-[(1-cyano-1-methylpropyl)azo]-2-ethyl; and
B. Butanenitrile, 2,2′-azobis(2-methyl-heptanenitrile], 2,2′-azobis(2-methyloctanenitrile), 2,2′-azobis(2-methyl-octanenitrile), 2-[(1-cyano-1-methylpropyl)azo]-2-methyl-octanenitrile, 2-[(1-cyano-1-methylhexyl)azo]-2-methyl-heptanenitrile, and 2-[(1-cyano-1-methylpropyl)azo]-2-methyl
the azodinitriles having a freezing point of a maximum of 25° C.

20. The multi-component liquid azo-peroxide initiator mixture of claim 16 wherein the azodinitriles are selected from the group consisting of mixtures C and D
C. Pentanenitrile, 2,2′-azobis(2-methyl-butanenitrile), 2,2′-azobis(2-ethyl-heptanenitrile), 2,2′-azobis(2-methyl-heptanenitrile), 2-[(1-cyano-1-methylbutyl)azo]-2-methyl-heptanenitrile, 2-[(1-cyano-1-ethylpropyl)azo]-2-methyl-pentanenitrile, 2-[(1-cyano-1-ethylpropyl)azo]-2-methyl; and
D. Butanenitrile, 2,2′-azobis(2-methyl-pentanenitrile), 2,2′-azobis(2-methyl-pentanenitrile), 2,2′-azobis(2,4-dimethyl-heptanenitrile), 2,2′-azobis(2-methyl-heptanenitrile), 2-[(1-cyano-1-methylpropyl)azo]-2-methyl-heptanenitrile, 2-[(1-cyano-1-methylbutyl)azo]-2-methyl-heptanenitrile, 2-[(1-cyano-1,3-dimethylbutyl)azo]-2-methyl-pentanenitrile, 2-[(1-cyano-1-methylbutyl)azo]-2,4-dimethyl-pentanentrile, 2-[(1-cyano-1-methylpropyl)azo]-2-methyl-pentanenitrile, and 2-[(1-cyano-1-methylpropyl)azo]-2,4-dimethyl
the azodinitriles having a freezing point of a maximum of 0° C.

21. The multi-component liquid azo-peroxide initiator mixture of claim 16 wherein the azodinitriles are selected from the group consisting of mixtures E, F and G
E. Butanenitrile, 2,2′-azobis(2-methyl-pentanenitrile), 2,2′-azobis(2-methyl-heptanenitrile), 2,2′-azobis(2-methyl-heptanenitrile, 2-[(1-cyano-1-methylpropyl)azo]-2-methyl-heptanenitrile, 2-[(1-cyano-1-methylbutyl)azo]-2-methyl-pentanenitrile, and 2-[(1-cyano-1-methylpropyl)azo]-2-methyl;
F. Butanenitrile, 2,2′-azobis(2-methyl-pentanenitrile), 2,2′-azobis(2-methyl-octanenitrile), 2,2′-azobis(2-methyl-octanenitrile), 2-[(1-cyano-1-methylpropyl)azo]-2-methyl-octanenitrile, 2-[(1-cyano-1-methylbutyl)azo]-2-methyl-pentanenitrile, and 2-[(1-cyano-1-methylpropyl)azo]-2-methyl; and
G. Butanenitrile, 2,2′-azobis(2-methyl-pentanenitrile), 2,2′-azobis(2-methyl-butanenitrile), 2,2′-azobis(2-ethyl-heptanenitrile), 2,2′-azobis(2-methyl-heptanenitrile), 2-[(1-cyano-1-methylpropyl)azo]-2-methyl-heptanenitrile, 2-[(1-cyano-1-methylbutyl)azo]-2-methyl-heptanenitrile, 2-[(1-cyano-1-ethylpropyl)azo]-2-methyl-pentanenitrile, 2-[(1-cyano-1-methylpropyl)azo]-2-methylpentanenitrile, 2-[(1-cyano-1-ethylpropyl)azo]-2-methyl-butanenitrile, and 2-[(1-cyano-1-methylpropyl)azo]-2-ethyl
the azodinitriles having a freezing point of a maximum of −15° C.

22. The multi-component liquid azo-peroxide initiator mixture of claim 16 wherein the liquid organic peroxides are selected from the group consisting of diacyl peroxides, peroxydicarbonates, peroxyesters, oo-t-alkyl o-alkyl monoperoxycarbonates, diperoxyketals, dialkyl peroxides, hydroperoxides, and ketone peroxides.

23. The multi-component liquid azo-peroxide initiator mixture of claim 22 wherein the diacyl peroxides are selected from the group consisting of diacetyl peroxide, diisononanoyl peroxide, and combinations thereof.

24. The multi-component liquid azo-peroxide initiator mixture of claim 22 wherein the peroxyesters are selected from the group consisting of t-butyl perbenzoate, t-butyl peracetate, t-amyl perbenzoate, 2,5-di(benzoylperoxy)-2,5-dimethylhexane, t-butyl peroxyisobutyrate, t-butyl peroxy-2-ethylhexanoate (t-butyl peroctoate), t-amyl peroctoate, 2,5-di(2-ethylhexanoylperoxy)-2,5-dimethylhexane, t-butyl peroxypivalate, t-amyl peroxypivalate, t-butyl peroxyneodecanoate, t-amyl peroxyneodecanoate, α-cumyl peroxyneodecanoate, and combinations thereof.

25. The multi-component liquid azo-peroxide initiator mixture of claim 17 wherein the azodinitriles are selected from the group consisting of mixtures E, F and G
E. Butanenitrile, 2,2′-azobis(2-methyl-pentanenitrile), 2,2′-azobis(2-methyl-heptanenitrile), 2,2′-azobis(2-methyl-heptanenitrile, 2-[(1-cyano-1-methylpropyl)azo]-2-methyl-heptanenitrile, 2-[(1-cyano-1-methylbutyl)azo]-2-methyl-pentanenitrile, and 2-[(1-cyano-1-methylpropyl)azo]-2-methyl;
F. Butanenitrile, 2,2′-azobis(2-methyl-pentanenitrile), 2,2′-azobis(2-methyl-octanenitrile), 2,2′-azobis(2-methyl-octanenitrile), 2-[(1-cyano-1-methylpropyl)azo]-2-methyl-octanenitrile, 2-[(1-cyano-1-methylbutyl)azo]-2-methyl-pentanenitrile, and 2-[(1-cyano-1-methylpropyl)azo]-2-methyl; and
G. Butanenitrile, 2,2′-azobis(2-methyl-pentanenitrile), 2,2′-azobis(2-methyl-butanenitrile), 2,2′-azobis(2-ethyl-heptanenitrile), 2,2′-azobis(2-methyl-heptanenitrile), 2-[(1-cyano-1-methylpropyl)azo]-2-methyl-heptanenitrile, 2-[(1-cyano-1-methylbutyl)azo]-2-methyl-heptanenitrile, 2-[(1-cyano-1-ethylpropyl)azo]-2-methyl-pentanenitrile, 2-[(1-cyano-1-methylpropyl)azo]-2-methylpentanenitrile, 2-[(1-cyano-1-ethylpropyl)azo]-2-methyl-butanenitrile, and 2-[(1-cyano-1-methylpropyl)azo]-2-ethyl
the azodinitriles having a freezing point of a maximum of −15° C. and the organic peroxide is selected from the from the group consisting of diacyl peroxides and peroxyesters.

26. The multi-component liquid azo-peroxide initiator mixture of claim 16 wherein the azodinitriles are selected from the group consisting of mixtures E, F and G
E. Butanenitrile, 2,2′-azobis(2-methyl-pentanenitrile), 2,2′-azobis(2-methyl-heptanenitrile), 2,2′-azobis(2-methyl-heptanenitrile, 2-[(1-cyano-1-methylpropyl)azo]-2-methyl-heptanenitrile, 2-[(1-cyano-1-methylbutyl)azo]-2-methyl-pentanenitrile, and 2-[(1-cyano-1-methylpropyl)azo]-2-methyl;
F. Butanenitrile, 2,2′-azobis(2-methyl-pentanenitrile), 2,2′-azobis(2-methyl-octanenitrile), 2,2′-azobis(2-methyl-octanenitrile), 2-[(1-cyano-1-methylpropyl)azo]-2-methyl-octanenitrile, 2-[(1-cyano-1-methylbutyl)azo]-2-methyl-pentanenitrile, and 2-[(1-cyano-1-methylpropyl)azo]-2-methyl; and
G. Butanenitrile, 2,2′-azobis(2-methyl-pentanenitrile), 2,2′-azobis(2-methyl-butanenitrile), 2,2′-azobis(2-ethyl-heptanenitrile), 2,2′-azobis(2-methyl-heptanenitrile), 2-[(1-cyano-1-methylpropyl)azo]-2-methyl-heptanenitrile, 2-[(1-cyano-1-methylbutyl)azo]-2-methyl-heptanenitrile, 2-[(1-cyano-1-ethylpropyl)azo]-2-methyl-pentanenitrile, 2-[(1-cyano-1-methylpropyl)azo]-2-methylpentanenitrile, 2-[(1-cyano-1-ethylpropyl)azo]-2-methyl-butanenitrile, and 2-[(1-cyano-1-methylpropyl)azo]-2-ethyl
the azodinitriles having a freezing point of a maximum of −15° C. and the organic peroxide is selected from the from the group consisting of diacetyl peroxide, diisononanoyl peroxide, t-butyl perbenzoate, t-butyl peracetate, t-amyl perbenzoate, 2,5-di(benzoylperoxy)-2,5-dimethylhexane, t-butyl peroxyisobutyrate, t-butyl peroxy-2-ethylhexanoate (t-butyl peroctoate), t-amyl peroctoate, 2,5-di(2-ethylhexanoylperoxy)-2,5-dimethylhexane, t-butyl peroxypivalate, t-amyl peroxypivalate, t-butyl peroxyneodecanoate, t-amyl peroxyneodecanoate, α-cumyl peroxyneodecanoate, and combinations thereof.

27. The multi-component liquid azo-peroxide initiator mixture of claim 16 wherein the azodinitriles are present in the azo-peroxide initiator mixture in an amount of from about 5 to about 95% by weight.

28. The multi-component liquid azo-peroxide initiator mixture of claim 22 wherein the azodinitrile initiators are present in the azo-peroxide initiator mixture in an amount of from about 5 to about 95% by weight.

29. In a process for the free radical polymerization of at least one radically polymerizable monomer to provide a polymerized homo- or copolymer employing as a liquid free radical initiator mixture, at least six different azodinitriles, wherein the improvement comprises substituting at least part of the azodinitrile mixture with at least one liquid organic peroxide.

30. In the process of claim 29, wherein the liquid organic peroxides are selected from the group consisting of diacyl peroxides, peroxydicarbonates, peroxyesters, oo-t-alkyl o-alkyl monoperoxycarbonates, diperoxyketals, dialkyl peroxides, hydroperoxides, and ketone peroxides.

31. In the process of claim 30 wherein the diacyl peroxides are selected from the group consisting of diacetyl peroxide, diisononanoyl peroxide, and combinations thereof.

32. In the process of claim 30 wherein the peroxyesters are selected from the group consisting of t-butyl perbenzoate, t-butyl peracetate, t-amyl perbenzoate, 2,5-di(benzoylperoxy)-2,5-dimethylhexane, t-butyl peroxyisobutyrate, t-butyl peroxy-2-ethylhexanoate (t-butyl peroctoate), t-amyl peroctoate, 2,5-di(2-ethylhexanoylperoxy)-2,5-dimethylhexane, t-butyl peroxypivalate, t-amyl peroxypivalate, t-butyl peroxyneodecanoate, t-amyl peroxyneodecanoate, α-cumyl peroxyneodecanoate, and combinations thereof.
